(19) United States
(12) Patent Application Publication
(10) Pub. No.: US 2008/0182143 A1
(43) Pub. Date: Jul. 31, 2008

(54) FUEL CELL SYSTEM WITH SERIES-PARALLEL CIRCUIT

(76) Inventors: MING-YAO DONG, Chupei (TW); Chun-Chin Tung, Chupei (TW)

Correspondence Address: G. LINK CO., LTD., 3550 BELL ROAD, MINOOKA, IL, 60447, US

(21) Appl. No.: 12/017,883

(22) Filed: Jan. 22, 2008

(30) Foreign Application Priority Data
Jan. 29, 2007 (TW) 096103228

(51) Int. Cl. H01M 8/04

(52) U.S. Cl. 429/23; 429/12

(57) ABSTRACT

The present invention relates to a fuel cell system with series-parallel circuit, comprising a plurality of fuel cell stacks, each fuel cell stack consisting of a fuel cell member and a DC voltage conversion unit; and a series-parallel circuit unit. The fuel cell member in respective fuel cell stack is electrically series-connected to the corresponding DC voltage conversion unit. The DC voltage conversion unit in each fuel cell stack includes a positive terminal and a negative terminal. The series-parallel circuit unit is electrically connected to the positive terminals and the negative terminals of the fuel cell stacks to form a specific electrical series-parallel connection relationship. The series-parallel circuit unit outputs the integrated power from the fuel cell stacks.

### FIELD OF THE INVENTION

The present invention relates to a fuel cell system with series-parallel circuit, particularly a kind of fuel cell system that provides control over the series-parallel connection relationship among a plurality of fuel cell stacks having DC voltage conversion unit and their power output.

### BACKGROUND OF THE INVENTION

Convention fuel cell uses hydrogen and oxygen to undergo electrochemical reaction and output power. It is an emerging energy source that provides electric power. Fuel cells commonly go through DC voltage conversion to control the output voltage for power supply. With respect to the means of DC voltage conversion, excessive voltage conversion ratio or improper conversion range would lower the conversion efficiency, which tends to increase power loss. Moreover, if the fuel cell adopts multi-stage voltage conversion, it would jack up its cost while the range of voltage conversion is still limited.

There are also fuel cell systems that integrate the power of a plurality of fuel cells through simple means of series-connection or parallel-connection and output power with specific voltage or current. But this type of fuel cell system must go through another DC voltage conversion in order to obtain more stable output voltage so as to satisfy the power demands of different loads.

In light of the drawbacks of conventional fuel cell system, the inventor aims to develop a fuel cell system with series-parallel circuit.

### SUMMARY OF THE INVENTION

The object of the invention is to provide a fuel cell system with series-parallel circuit to address the phenomenon where the voltage of the fuel cell tends to drift with load and the greater the number of serially connected fuel cell stacks, the more drastic the voltage fluctuation. The present invention is characterized in which after a plurality of fuel cell stacks in the fuel cell system have undergone voltage conversion, their powers are integrated by a specific series-parallel circuit and effectively output to meet specific power demands such that the power from each fuel cell stack only needs to go through one-stage voltage conversion to achieve more economical and efficient conversion.

Another object of the invention is to provide a fuel cell system with series-parallel circuit, which can, by controlling the conversion of respective voltage output by a plurality of fuel cell stacks, regulate the characteristics of output voltage or current that has passed through the series-parallel circuit.

Yet another object of the invention is to provide a fuel cell system with series-parallel circuit in which a plurality of fuel cell stacks undergo voltage conversion, and by controlling the series-parallel circuit of those fuel cell stacks, the topology of the series-parallel circuit is altered to regulate the characteristics of output voltage or current that has passed through the series-parallel circuit.

To achieve the aforesaid objects, the invention provides a fuel cell system with series-parallel circuit, comprising a plurality of fuel cell stacks, each fuel cell stack consisting of a fuel cell member and a DC voltage conversion unit; and a series-parallel circuit unit; wherein the fuel cell member in respective fuel cell stack is electrically series-connected to the corresponding DC voltage conversion unit, and the DC voltage conversion unit in each fuel cell stack includes a positive terminal and a negative terminal; the series-parallel circuit unit is electrically connected to the positive terminal and the negative terminal of respective fuel cell stacks to form a specific electrical series-parallel connection relationship, and the series-parallel circuit unit outputs the integrated power from the fuel cell stacks.

The objects, features and effects of the invention are described in detail below with embodiments in reference to the accompanying drawings.

### BRIEF DESCRIPTION OF THE DRAWINGS

FIG. 1 is a component diagram of a fuel cell system with series-parallel circuit according to an embodiment of the invention;

FIG. 2 is a component diagram of a fuel cell system with series-parallel circuit according to another embodiment of the invention; and

FIG. 3 is a component diagram of a fuel cell system with series-parallel circuit according to vet another embodiment of the invention.

### DETAILED DESCRIPTION OF THE INVENTION

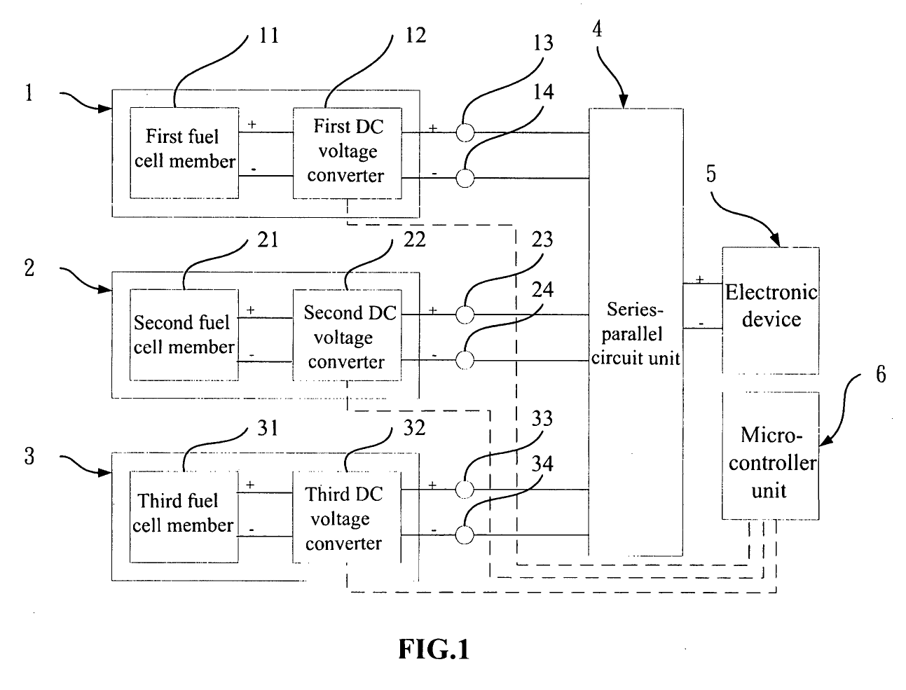

FIG. 1 is a component diagram of a fuel cell system with series-parallel circuit according to an embodiment of the invention. The fuel cell system with series-parallel circuit comprises a plurality of fuel cell stacks including a first cell stack (1), a second fuel cell stack (2), and a third cell stack (3), which are electrically connected through a series-parallel circuit unit (4). The series-parallel circuit unit (4) is electrically connected to an electronic device (5) such that the power generated by the fuel cell stacks can be transmitted to the electronic device (5).

In the fuel cell system with series-parallel circuit of the invention, the first fuel cell stack (1) consists of a first fuel cell member (II) and a first DC voltage conversion unit (12), the first fuel cell member (11) being electrically series-connected to the first DC voltage conversion unit (12) and electrically connected to the series-parallel circuit unit (4) through a first positive terminal (13) and a first negative terminal (14) of the first fuel cell stack (1); the second fuel cell stack (2) consists of a second fuel cell member (21) and a second DC voltage conversion unit (22), the second fuel cell member (21) being electrically series-connected to the second DC voltage conversion unit (22) and electrically connected to the series-parallel circuit unit (4) through a second positive terminal (23) and a second negative terminal (24) of the second fuel cell stack (2); the third fuel cell stack (3) consists of a third fuel cell member (31) and a third DC voltage conversion unit (32), the third fuel cell member (31) being electrically series-connected to the third DC voltage conversion unit (32) and electrically connected to the series-parallel circuit unit (4) through a third positive terminal (33) and a third negative terminal (34) of the third fuel cell stack (3); and the series-parallel circuit unit (4) is electrically connected to the first fuel cell stack (1), the second fuel cell stack (2), and the third fuel cell stack (3) such that the fuel cell stacks form a specific electrical series-parallel connection relationship.

As such, by designing the electric output characteristics of the fuel cell stacks, such as choosing the first fuel cell stack (1), the second fuel cell stack (2), and the third fuel cell stack (3) to output respectively electric power with specific voltage, current or power, which, after electrical connection via the series-parallel circuit unit (4), is integrated into power having another specific voltage, current or power for output to the electronic device (5). Specifically, the first DC voltage conversion unit (12) of the first fuel cell stack (1), the second DC voltage conversion unit (22) of the second fuel cell stack (2), and the third DC voltage conversion unit (32) of the third fuel cell stack (3) can be respectively a DC voltage converter having different DC voltage conversion ratio such that the first fuel cell stack (1), the second fuel cell stack (2), and the third fuel cell stack (3) can respectively output a different DC voltage. Through series-aiding connection via the series-parallel circuit unit (4), the output voltages from respective fuel cell stacks can be added up for power output. As such, power with another electric output characteristics may be obtained by changing the series-parallel connection relationship among the fuel cell stacks.

The fuel cell system with series-parallel circuit of the invention further includes a microcontroller (6), the microcontroller (6) being able to select the DC voltage conversion ratio of the first DC voltage conversion unit (12), the second DC voltage conversion unit (22), and the third DC voltage conversion unit (32) such that the first fuel cell stack (1), the second fuel cell stack (2), and the third fuel cell stack (3) can output different DC voltage.

In the aforesaid embodiment of the fuel cell system with series-parallel circuit, the fuel cell stacks of the fuel cell system undergo voltage conversion and regulation via a DC voltage conversion unit so that the power of each fuel cell stack is subject to only one-stage voltage conversion. As the number of series-connected fuel cell stacks increases, voltage fluctuation will be more drastic. Thus by subjecting individual fuel cell stacks to voltage conversion and integrating the output voltages via a specific series-parallel circuit, power of desired characteristics can be effectively output to address the phenomenon where the voltage of fuel cell tends to drift with the load, thereby obtaining more economical and greater voltage conversion efficiency.

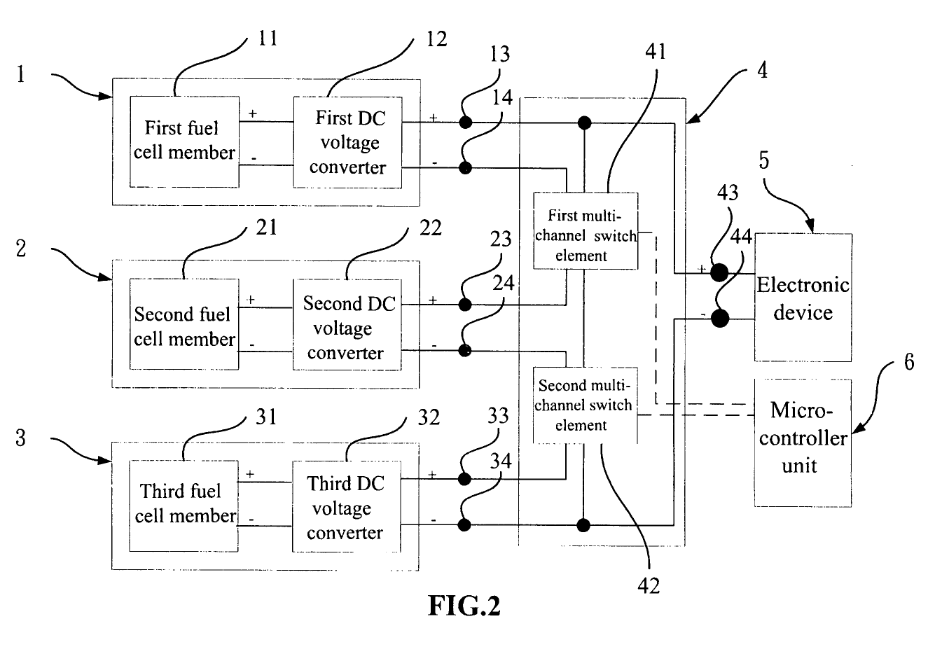

FIG. 2 is a component diagram of a fuel cell system with series-parallel circuit according to another embodiment of the invention. The series-parallel circuit unit (4) in the embodiment is a logic circuit to which the fuel cell stacks are electrically connected such that the topology of the logic circuit in the series-parallel circuit unit (4) can be decided by the microcontroller (6) to further alter the series-parallel connection relationship among the fuel cell stacks and obtain power with electric output characteristics. Specifically, the first fuel cell stack (1), the second fuel cell stack (2), and the third fuel cell stack (3) form an electric series-connection relationship via the series-parallel circuit unit (4), and the series-parallel circuit unit (4) further includes a first multi-channel switching element (41), a second multi-channel switching element (42), a positive output terminal (43), and a negative output terminal (44), the first multi-channel switching element (41) and the second multi-channel switching element (42) being respectively a multiport-to-multiport multi-channel switching element, the electrical connection relationship between the corresponding ports of the first multi-channel switching element (41) and the second multi-channel switching element (42) being selected by the microcontroller (6), the first multi-channel switching element (41) being able to choose that the first negative terminal (14) being electrically connected to the second positive terminal (23), the first negative terminal (14) being electrically connected to the second multi-channel switching element (42), the second positive terminal (23) being electrically connected to the positive output terminal (43) or the second multi-channel switching element (42) being electrically connected to the positive output terminal (43), the second multi-channel switching element (42) being able to choose that the second negative terminal (24) being electrically connected to the third positive terminal (33), the second negative terminal (24) being electrically connected to the negative output terminal (44), the third positive terminal (33) being electrically connected to the first multi-channel switching element (41) or the first multi-channel switching element (41) being electrically connected to the negative output terminal (44) such that the series-parallel circuit unit (4) can choose arbitrarily the series-parallel connection pattern of the fuel cell stacks to achieve the control of voltage output.

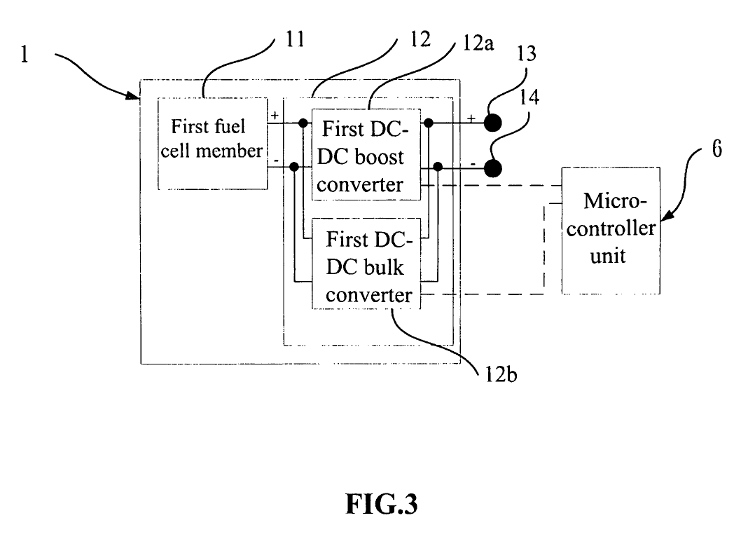

FIG. 3 is a component diagram of a fuel cell system with series-parallel circuit according to yet another embodiment of the invention. In the fuel cell system with series-parallel circuit, the DC voltage conversion units of the fuel cell stacks are DC voltage converters having different DC voltage conversion ratio such that respective fuel cell stacks can output a different DC voltage. Through series-aiding connection via the series-parallel circuit unit (4), the output voltages from respective fuel cell stacks can be added up for power output. Specifically, take the example of the first fuel cell stack (1), the first DC voltage conversion unit (12) of the first fuel cell stack (1) further includes a first DC-DC boost converter (12a) and a first DC-DC buck converter (12b), the first DC-DC boost converter (12a) being a DC voltage converter having a specific step-up conversion ratio, the first DC-DC buck converter (12b) being a DC voltage converter having a specific step-down conversion ratio. Through the microcontroller (6), it can be decided whether the first DC voltage conversion unit (12) of the first fuel cell stack (1) would carry out output voltage conversion via the first DC-DC boost converter (12a) or the first DC-DC buck converter (12b) so as to achieve control over the power output of the first fuel cell stack (1).

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A fuel cell system with series-parallel circuit, comprising:
a plurality of fuel cell stacks, each fuel cell stack consisting of a fuel cell member and
a DC voltage conversion unit; and
a series-parallel circuit unit;
wherein the fuel cell member in each fuel cell stack is electrically connected to the corresponding DC voltage conversion unit, the DC voltage conversion unit in the fuel cell stack contains a positive terminal and a negative terminal, the series-parallel circuit unit is electrically connected to the positive terminal and the negative terminal of each fuel cell stack to form a specific electrical series-parallel connection relationship and the series-parallel circuit unit outputs the integrated power from the fuel cell stacks.

2. The fuel cell system with series-parallel circuit according to claim 1, wherein a fuel cell stack in the plurality of fuel cell stacks is defined as a firsts fuel cell stack, and another fuel cell stack is defined as a second fuel cell stack, the positive terminal and the negative terminal of the first fuel cell stack is respectively defined as a first positive terminal and a first negative terminal, the positive terminal and the negative terminal of the second fuel cell stack are respectively defined as a second positive terminal and a second negative terminal; the series-parallel circuit unit further includes a first multi-channel switching element; and the first multi-channel switching element select either the state of the first negative terminal being electrically connected to the second positive terminal or the second positive terminal being electrically connected and outputs to the positive terminal.

3. The fuel cell system with series-parallel circuit according to claim 2, wherein yet another fuel cell stack in the plurality of fuel cell stacks is defined as a third fuel cell stack, the positive terminal and the negative terminal of the third fuel cell stack are respectively defined as a third positive terminal and a third negative terminal; the series-parallel circuit unit further includes a second multi-channel switching element; the first multi-channel switching element selects further any state of first negative terminal being electrically connected to the second positive terminal, the second positive terminal being electrically connected and outputs to the positive terminal, the first negative terminal being electrically connected to the second multi-channel switching element, and the second multi-channel switching element being electrically connected and outputs to the positive terminal; and the second multi-channel switching element selects any state of the second negative terminal being electrically connected to the third positive terminal, the second negative terminal being electrically connected and outputs to the negative terminal, the third positive terminal being electrically connected to the first multi-channel switching element and the first multi-channel switching element being electrically connected and outputs to the negative terminal.

4. The fuel cell system with series-parallel circuit according to claim 2, wherein at least one DC voltage conversion unit corresponding to the fuel cell stack in the plurality of fuel cell stacks further includes a DC-DC boost converter and a DC-DC buck converter, the DC-DC boost converter being a DC voltage converter having a specific step-up conversion ratio, the DC-DC buck converter being a DC voltage converter having a specific step-down conversion ratio, and a microcontroller being able to choose whether the DC voltage conversion unit carries out output voltage conversion via the DC-DC boost converter or the DC-DC buck converter.

5. The fuel cell system with series-parallel circuit according to claim 2, wherein the first fuel cell stack and the second fuel cell stack form an electrical series-connection relationship via the series-parallel circuit unit and the series-parallel circuit unit outputs the integrated power from the fuel cell stacks.

6. The fuel cell system with series-parallel circuit according to claim 2, wherein the first fuel cell stack and the second fuel cell stack form an electrical parallel-connection relationship via the series-parallel circuit unit and the series-parallel circuit unit outputs the integrated power from the fuel cell stacks.

7. The fuel cell system with series-parallel circuit according to claim 1, further comprising a microcontroller; the series-parallel circuit unit being a logic circuit and electrically connected to the plurality of fuel cell stacks; the microcontroller being able to choose the topology of the logic circuit in the series-parallel circuit unit.

8. The fuel cell system with series-parallel circuit according to claim 1, wherein the DC voltage conversion units in respective fuel cell stacks are DC voltage converter having different DC voltage conversion ratio.

9. The fuel cell system with series-parallel circuit according to claim 1, further comprising a microcontroller, the microcontroller being able to choose the DC voltage conversion ratio of the DC voltage conversion unit in respective fuel cell stack.
